(19) United States
(12) Patent Application Publication
(10) Pub. No.: US 2015/0220420 A1
(43) Pub. Date: Aug. 6, 2015

(54) PERFORMANCE EVALUATION AND TUNING SYSTEMS AND METHODS

(71) Applicant: Schlumberger Technology Corporation, Sugar Land, TX (US)

(72) Inventors: Carlos Santieri de Figueiredo Boneti, Houston, TX (US); Eliana Mendes Pinto, Rio de Janeiro (BR)

(73) Assignee: Schlumberger Technology Corporation, Sugar Land, TX (US)

(21) Appl. No.: 14/284,951

(22) Filed: May 22, 2014

Related U.S. Application Data
(60) Provisional application No. 61/934,329, filed on Jan. 31, 2014.

(51) Int. Cl. G06F 11/36

(52) U.S. Cl. CPC G06F 11/3612

(57) ABSTRACT

Methods for performance evaluation and tuning are provided. In an embodiment, the method includes defining a performance goal for a variable in a scenario, and executing the application using the scenario, after defining the performance goal. The method also includes recording a value of the variable, e.g., during execution of the application, and determining that the value of the variable does not meet the performance goal for the variable. The method includes profiling an execution of the application in the scenario, and determining a non-critical path of the application and a critical path, based on the profiling. The method further includes identifying a bottleneck in the critical path based on the profiling, and tuning the application to address the bottleneck and generate a tuned application, with the non-critical path not being tuned. The method also includes executing the tuned application, and determining whether the tuned application meets the performance goal.

### CROSS-REFERENCE TO RELATED APPLICATIONS

This application claims priority to U.S. Provisional Patent Application having Ser. No. 61/934,329, filed on Jan. 31, 2014, the entirety of which is incorporated herein by reference.

### BACKGROUND

“Performance” is a quality attribute of software systems. Failure to meet performance requirements may have negative consequences, such as damaged customer relations, reduced competitiveness, business failures, and/or project failure. On the other hand, meeting or exceeding performance requirements in products can produce opportunities for new usages, new demands, new markets, and the like.

Performance analysis is a process of determining the performance of a software application and comparing it to the relevant performance standards. When the performance analysis reveals that the software application does not meet performance targets, or otherwise could be improved, the software application may be tuned. Tuning is the process of adjusting the logic, structure, etc. of the application to enhance performance.

Tuning techniques are typically learned through personal experience, through which an engineer gains insight into particular software algorithms and structures and is able to intuitively recognize structure, logic, etc., that can be changed to increase performance. This ad-hoc type of process, however, is often not captured through formal documentation within institutions, and thus the tuning process can vary according to personnel. Moreover, such tuning processes are prone to errors. For example, an engineer may assume that a code segment is particularly suited for improvement, when in fact other areas of the program are hindering performance to a greater degree. This type of error may be caused by a variety of factors that may bring a certain algorithm or process to the forefront of the engineer's mind, such as recent literature that identifies cutting-edge ways to improve performance, when more mundane problems are affecting performance to a greater degree. In development teams, such performance tuning is typically seen as a complex and ill-defined task that hides many pitfalls.

### SUMMARY

Embodiments of the disclosure may provide methods for evaluation and performance tuning. For example, one such method consistent with the present disclosure may include defining a performance goal for a variable in a scenario of an execution of an application, and executing, using a processor, the application using the scenario, after defining the performance goal. The method may also include recording a value of the variable during execution of the application, or after execution of the application, or both, and determining that the value of the variable does not meet the performance goal for the variable. The method may also include profiling an execution of the application in the scenario, and determining a non-critical path of the application and a critical path of the application, based on the profiling. The method may further include identifying a bottleneck in the critical path based on the profiling, and tuning the application using the profile to address the bottleneck and generate a tuned application, wherein the non-critical path is not tuned. The method may also include executing the tuned application using the scenario, and determining whether the value of the variable for the tuned application meets the performance goal.

The foregoing summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for performance evaluation and tuning, according to an embodiment.

FIG. 2 illustrates an example of an instrumentation profile report, according to an embodiment.

FIG. 3 illustrates team performance roles during project life cycle, according to an embodiment.

FIG. 4 illustrates a schematic view of a processor system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

Embodiments of the present disclosure may provide an integrated method for performance analysis and tuning. In performing the method, users (e.g., managers, engineering teams, commercialization teams, portfolio teams, etc.) may follow an organized process of identifying a use case in which the software application is to be implemented, defining performance goals tailored to the use case, and analyzing software performance with respect to the predefined goals. If the software application is determined to fall short of the performance goals, a tuning routine may be implemented.

The tuning routine may be organized to begin with establishing one or more baselines for code performance, identifying bottlenecks, and mitigating such bottlenecks through tuning identified hotspots. Once revised, the performance of the code may again be analyzed. The tuning routine may be repeated iteratively until performance goals are reached. Thus, in at least one example, the present method provides a structured, integrated approach that may incorporate input from several different teams and then proceeds through the tuning routine in a structured manner to reach the goals set.

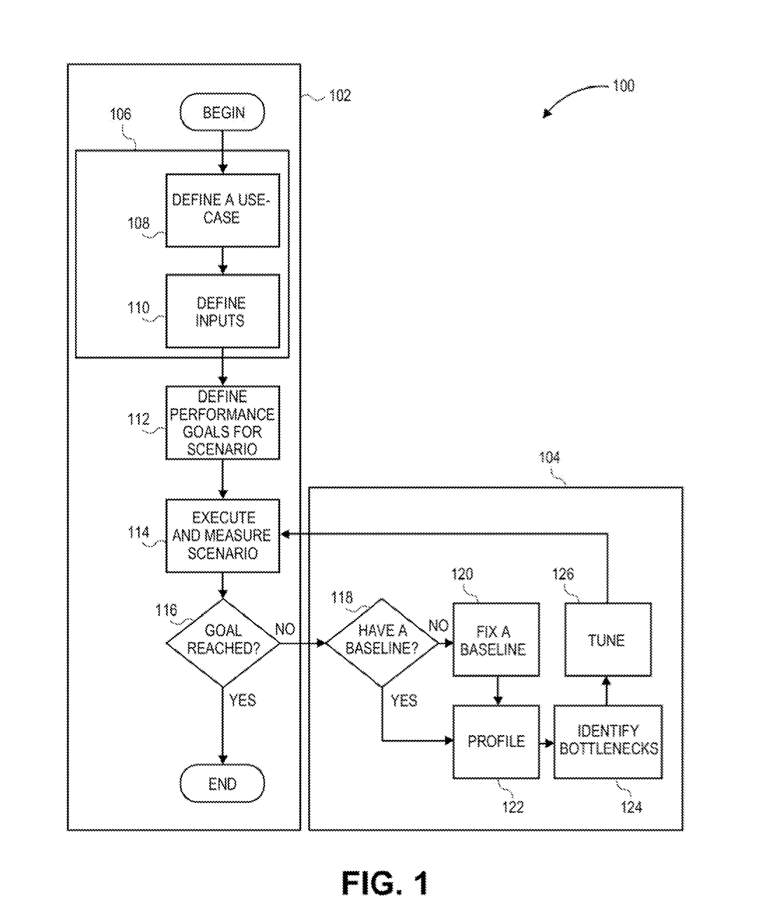

Referring now to the illustrated embodiments, FIG. 1 depicts a flowchart of a method 100 for performance evaluation and tuning of a software application. The method 100 may generally be considered in two parts: performance evaluation 102 and a tuning routine 104. It will be appreciated that the method 100 may be further partitioned and/or may include other parts, with the illustrated parts 102, 104 being merely one descriptive example. The performance evaluation 102 may be performed, for example, by portfolio, commercialization, and/or engineering teams. The portfolio team may interface with a client, for example, to establish features and performance items for the software. The engineering team may include software developers, coders, etc. The commercialization team may test the products against the performance goals in the use cases.

In a variety of cases, the performance evaluation 102 may begin with building a scenario, as at 106. A scenario generally describes a test case, in which a use case and its variables or metrics (project, version, parameters, inputs, etc.) are defined for execution. A “use case” is one or more steps that define interactions between the user and the system in order to achieve a goal.

In some embodiments, several scenarios may be considered for one use case, including, for example, any and/or all scenarios that may be considered “critical.” A scenario may be considered critical, in some contexts, as determined by the variables used for execution, such as project data size (e.g., criticality increasing proportionally to the data size), or a specific input (e.g., a log with many samples or a large parameter value) that could generate a performance issue. In general, critical scenarios are scenarios that are relatively likely, compared to other scenarios, of having a performance issue.

As shown, building the scenario at 106 may include defining a use case, as at 108, and defining inputs, as at 110. The use case may be defined as one or more features that are handled by the software package. For example, one use case may be “create representations of 1,000 wells in the interface.” Accordingly, the use case may drive the creation of the software application, so that the application performs the intended functionality. The method 100 may, in some cases, begin with a working application to be tested for performance. In other cases, the application may be created after the use case and scenarios are defined.

The inputs defined at 110 may be provided to apply the software application to the use case. Certain performance issues may be detected when using large data sets for product testing. Accordingly, the inputs may be provided as data files that mimic, resemble, or are otherwise similar in the size, scale, and complexity to the data set employed during end-user operation.

Commercialization and portfolio teams may have large datasets and/or client projects with significant amounts of input data. Accordingly, the commercialization team may apply the performance evaluation process for each tested use case and report performance issues to the engineering team. The portfolio team may serve a supporting role in this aspect, for example, by providing the significant inputs to engineering and commercialization.

Further, the method 100 may include analyzing one, some, or all of the variables that may affect the execution time of the use case. Because the environment where the tests are running can impact on the results, several variables may be controlled, such as the applications running in the system, other tests running in parallel, and the hardware where the tests are being executed, as will be discussed in greater detail below.

The method 100 may then proceed to defining the performance goals, as at 112, e.g., for one or more scenarios. For example, the method 100 may define a set of performance parameters, which may include the performance goals. An example of performance parameters in a scenario are set forth in Table 1 below.

TABLE 1
Performance Parameters
Wavelet Toolbox
Extended White Method

| | |
|---|---|
| Scenario | Use case: User extracts a deterministic |
| | wavelet using Extended White Method |
| | Project: Project X |
| | Well: Well X |
| | Seismic: Mig |
| | Reflectivity method: from sonic and density. |
| | Logs: DT, RHOB |
| | Inline and xline window: 40 |
| | Inline: 548 |
| | Xline: 540 |
| Measurement Criteria | Execution time |
| Machine | Dell M6500, Intel core i7 X940 2.13 GHz, |
| | 16 GB RAM |
| Benchmark | Available software executes scenario in |
| | 10 seconds |
| Performance goal | The user must perform the use case in the |
| | scenario in less than or equal to 8 seconds. |

As can be appreciated, the performance parameters may take the particular scenario into consideration, including the machine upon which the application is being executed, since optimized or more powerful computing systems may perform certain processes faster than others, despite optimized code. The performance parameters may specify what is being measured (variously referred to as “measurement criterion,” “performance metric” or “performance variable”) and establish a benchmark against which a value of this criterion measured during application execution may be compared. The benchmark may be a performance of a competing application, or a current standard product, in the scenario, or may be established according to user needs, operation as a part of a larger system, or arbitrarily.

The performance goal and the benchmark may be in the same domain. In the example case of Table 1, the measurement criterion and benchmark are both execution time; however, other measurement criteria may be employed. In some cases, the performance goal may be stricter (e.g., more rigorous) than the benchmark. Performance goals may be defined such that they are reasonably achievable, while achieving the goals results in satisfactory application performance. In addition, having stricter goals may enable new usability paradigms (e.g., interactive user interfaces (UIs), etc.).

The portfolio team may contribute by defining the performance parameters, e.g., goals, for the business-critical scenarios. As noted above, in some cases benchmarks may be used to determine a goal based on the performance achieved by competitors. Conversely, if a feature is new to the market, it can be difficult to set a performance goal in an early application development cycle. In certain circumstances, setting a performance goal early in the method 100 may prompt the engineer to at least evaluate performance, even if the goal is ultimately unrealistic.

The method 100 may then proceed to executing the software application using the parameters established at 112, and measuring a performance value for the application in the scenario, as at 114. For example, as the use cases are delivered, the method 100, at 114, may include testing the application against the performance goal defined at 112. By executing the application and measuring the scenario built at 106, and by having a predefined goal established at 112, the method 100 may include determining whether the goal was reached, as at 116. For example, the value (e.g., execution time) measured at 114 may be compared to the performance goal, e.g., as established at 112.

To address execution time variability, applications may be executed multiple times for a scenario. Each execution time may be recorded and/or stored in a list of execution times, so that the mean time value of each member of the list can be established as the performance value. If the mean value is better than the defined goal, then the performance evaluation may be complete. If not, performance tuning in the tuning routine 104 of the method 100 may be employed for the application being evaluated.

Before describing an embodiment of the tuning routine 104, at this point of the disclosure, it is apparent that premature tuning is prevented from occurring as part of this method 100. The scenario and performance goal (e.g., execution time) are established before tuning occurs. Accordingly, aspects of the application that perform adequately or are not critical to overall software performance may not be tuned, thus moving the performance evaluation of the software to the next scenario or use case. Should performance, as measured by the measurement criteria, fall short of the performance goal(s), however, the method 100 may proceed to the tuning routine 104.

In the tuning routine 104, the method 100 may include a tuning process which may be performed by the engineering team, for example. The performance tuning routine 104 may be an iterative process, which may identify and eliminate bottlenecks, e.g., one, two, or more at a time until, the application meets its performance parameters. The term “bottleneck” is used herein to indicate a situation where the performance of a use case is limited by one or a few code segments of the application. Moreover, some bottlenecks may lie on the application's critical path and may limit throughput. Accordingly, bottlenecks may be identified and/or analyzed, ranked, etc. to identify those that are candidates for mitigation by tuning.

The tuning routine 104 may begin by determining whether a baseline has been established for the performance of the application in the scenario, as at 118. If a baseline has not been established (e.g., for a first iteration of the tuning routine 104), the method 100 may proceed to defining or otherwise fixing a baseline, from which performance improvement may be measured, as at 120. To determine the baseline at 120, the method 100 may not only establish a metric associated with the performance goal, but also inventory other aspects of the scenario, e.g., the parameters under which the software application is operating in the use case. To this end, at 120, the method 100 may include recording various variables related to the scenario, for example, the version, project, inputs, parameters, hardware description and others that compose the scenario. The same scenario may be executed after tuning, so as to measure the performance impact by comparing the new execution time with the one before tuning.

Execution time (also referred to as “run time” or “response time”) may be measured in any one of a variety of ways and according to a variety of execution parameters. For example, in some applications, the execution time may be monitored by inserting a “stopwatch” function call before and after the code that performs the scenario being evaluated. The following pseudocode is illustrative of such stopwatch functionality and includes multiple recordings of the stopwatch, to account for execution-time variability, as discussed above.

Pseudocode for an example of Execution Time Determination

Function ComputeExecutionTimeForProgram

Loop a number of times until reasonably certain that time variances
will be statistically eliminated. Within each loop:

Start stopwatch;
Execute program;
End stopwatch;
Record elapsed time as indicated by the stopwatch;
Reset the stopwatch.

Determine average elapsed time for executing the program in each
iteration of the loop.

Accordingly, when fixing the baseline at 120, the execution time may be determined using this or another algorithm. This execution time, together with the other factors of the scenario, may be stored as the baseline, at least in an initial iteration of the tuning routine 104.

Depending on, e.g., the criticality of the scenario, there may be several acceptable ways to measure performance using unit testing. For example, instead of specifying a concrete number of times to execute, a standard deviation limit may be specified and the application may be executed several times in the scenario, until the standard deviation of the resulted time values reaches the limit. Below, there is presented an example of pseudocode for one example of such a technique.

Pseudocode for another example of Execution Time Determination

Function ComputeExecutionTimeForProgram

While the number of completed loops is less than three or the
standard deviation is greater than acceptable:

Start stopwatch;
Execute program;
End stopwatch;
Record elapsed time as indicated by the stopwatch;
Reset the stopwatch.

Determine average elapsed time for executing the program in each
iteration of the loop

The tolerable standard deviation may be determined according to the criticality of the scenario (e.g., according to its visibility to the end-user, effect in the overall software package, etc.) or other factors. Moreover, the standard deviation may be established in concrete terms, or as a percentage of the baseline or performance goal, etc. The standard deviation limit may be defined as being a percentage of the performance goal. The percentage may be between about 0.1% and about 10%, about 0.5% and about 5%, about 1% and about 3%, or about 2%, for example. A variety of other percentage ranges are contemplated herein.

The technique may also specify lower and/or upper bounds for the number of times to execute the application. As provided in the pseudocode above, the lower bounds may be provided to develop a robust list of times, thereby establishing a more reliable standard deviation. Additionally, the upper bounds may be provided to prevent lengthy evaluation run times. In an example, the lower bounds may be at least about 10 runs, at least about 5 runes, or at least about 3, and the upper bounds may be between 10 and 100 runs, e.g., about 40 runs.

Further, the tuning routine 104 may include developing a profile (also referred to in the art as “profiling”), as at 122. Profiles may be established in several different ways, using a variety of off-the-shelf or custom profiling tools. For example, one way of profiling is referred to as “instrumentation.” The instrumentation profiling method collects detailed timing information for the function calls in a profiled application. Instrumentation profiling may be used, inter alia, for investigating input/output bottlenecks such as disk I/O and/or close examination of a particular module or set of functions. In an embodiment, instrumentation profiling injects code into a binary file that captures timing information for each function in the instrumented file and each function call that is made by those functions. Instrumentation profiling also identifies when a function calls into the operating system for operations such as writing to a file.

Another way of profiling is referred to as “sampling.” Sampling profiling collects statistical data about the work that is performed by an application during a profiling run. Sampling may be used, for example, in initial explorations of the performance of the application, and/or investigating performance issues that involve the utilization of the processor. In general, sampling profiling interrupts the computer processor at set intervals and collects the function call stack. Exclusive sample counts may be incremented for the function that is executing and inclusive counts are incremented for all of the calling functions on the call stack. Sampling reports (profiles) may present the totals of these counts for the profiled module, function, source code line, and instruction. The examples of profiling by instrumentation and profiling by sampling are but two examples among many contemplated for use in accordance with this disclosure.

Accordingly, one or more profiling processes may be employed to develop the profile, which may provide information indicative of critical paths of the application, problematic (from an execution time standpoint) functions, etc. Thus, the profile may describe a performance issue found in the execution of the application in the particular scenario. Having a performance goal established at 112, prior to profiling at 122, may ensure that the method 100 avoids optimizing a part of the application that is not on the critical path. Profiling may also occur before tuning the application, as profiling may promote avoiding false bottleneck assumptions, since the profile may indicate where “hotspots” are found. Hotspots may arise from an unnecessary execution path that may be eliminated, from repetitive calls of an execution path, from unnecessary triggering events, from a loop that could be parallelized, and in other ways.

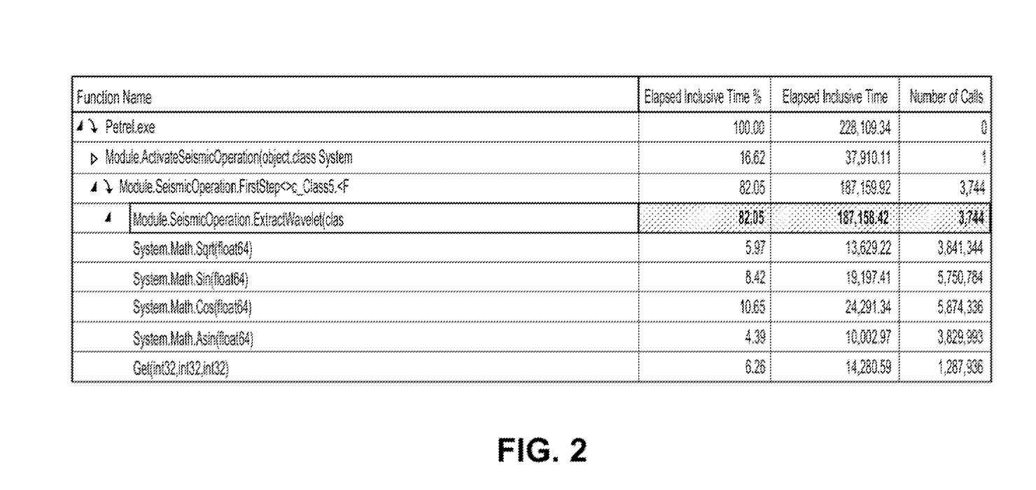

The method 100 may then proceed to identifying bottlenecks, as at 124. Identifying bottlenecks may include analyzing areas identified as being potentially problematic in the profile. As an illustrative example, and not by way of limitation, FIG. 2 shows a summary tree of an instrumentation profile report. The tree report indicates four columns, titled: Function Name, Elapsed Inclusive Time (%), Elapsed Inclusive Time (msec), and Number of Calls. The hotspot is indicated as being inside the function “ExtractWavelet” which is highlighted in FIG. 2.

In the example shown in FIG. 2, the calls to the “System.Math” functions represent almost 30% of the elapsed inclusive time. Accordingly, this may result in a determination to optimize the math functions or use another math library, which could potentially result in a better performance. However, the “Number of Calls” column indicates that the cosine function was called more than 5 million times inside a function that was called 3,744 times. Hence, for this example a better way to parallelize this function call may be determined. If, even after such parallelization, the function call still does not reach its performance goal, a code refactor may be considered to reduce the number of calls for these math functions.

The method 100 may then proceed to tuning, as at 126. For example, the method 100 may include applying code optimization on the previously-identified hotspots. Such tuning may be done in several ways and may depend on the results of the hotspot analysis (e.g., identifying bottlenecks at 124). Tuning may employ parallelization, code refactors, or other ways to optimize code in order to tune the application, including, for example, application programming interface (API) changes. It will be appreciated that “code refactor” generally refers to restructuring an existing body of code, so as to alter its internal structure without changing its external behavior. Further, the precise tuning may be partially dependent upon the hardware profile of the scenario.

The method 100 may then proceed back to executing and measuring the scenario, as at 114, including measuring the performance impact, e.g., as shown in Table 2, below. If the tuning 126 does not result in the execution of the application reaching the performance goal, then profiling at 122, identifying bottlenecks at 124, and tuning at 126 may be conducted again, with the result of the previous iteration, in some cases, serving as the new baseline, until the goal is reached. Once the goal is reached, the performance of the final iteration may be compared against the original baseline to determine an overall gain realized in the iterative tuning process.

TABLE 2
Performance measurement example

| | Scenario A | Scenario B |
|---|---|---|
| Execution time from baseline (s) | 5.75 | 8.67 |
| Goal | Less than | Less than |
| | 5 seconds | 5 seconds |
| Execution time after tuning (s) | 4.22 | 3.78 |
| Speedup factor | 1.36 | 2.29 |
| Performance gain (%) | 36 | 129.3 |

where:

$$\begin{matrix}Speedup factor = \frac{execution time from baseline}{execution time after tuning} & ( 1 ) \\ Performance gain = ( speedup factor - 1 ) * 100 & ( 2 )\end{matrix}$$

Equation (1) defines the “speedup factor,” which measures the change (reduction) in execution time realized by the tuning. As shown in Table 2, for example, scenario A is executed 1.36 times faster than the baseline. The “performance gain” represents the percentage of improvement. It is calculated using the speedup factor, as shown in equation (2). Equations (1) and (2) may be related to an efficacy of the tuning routine 104.

In some cases, however, the iterative tuning routine 104 may exhibit attenuated performance gains, and/or the defined performance goal may be determined to be unrealistic, demand excessive engineering time to obtain a small gain in performance, and/or the like. Accordingly, in some cases, the tuning routine 104 may be terminated prior to establishing an execution time in the scenario that meets the stated performance goal, or, in another case, the performance goal may be revised, such that the tuning routine 104 terminates normally using the revised goal. Thus, in an embodiment, if the performance gain (or speedup factor) is deemed to be too small (e.g., below a predetermined threshold which may vary according to a number of iterations of the tuning process), the determination of which may include the number of iterations performed, in tuning the code to mitigate one bottleneck or a certain set of bottlenecks, the tuning routine 104 may move to another bottleneck or set of bottlenecks identified at 124. If no other bottlenecks are apparent, or if the execution of the application in the scenario meets the goal at 116, the method 100 may end.

The method 100 thus includes performance evaluation, tuning, requirements definition, and unit testing processes along a project lifecycle. These processes can be applied in multiple ways and may depend on the project development process being used. For example, where the project development is an iterative and incremental process, each iteration may produce a release of the product even if it does not add enough functionality to warrant a market release. As a result, scenarios may develop for evaluation at the end of each iteration. Moreover, at any point. e.g., including the beginning, of the construction phase, there may be use cases ready to test and performance evaluation and tuning may already be considered.

Applying the performance evaluation and tuning processes from the beginning of project construction may promote avoidance of large code refactors or architecture modifications due to performance issues. Further, time may be allocated to evaluate the performance of each implemented use case. A performance evaluation task may be recorded for each implemented use case and a time box may be allocated for that task. If a specific scenario fails to reach the performance goal defined for it, then another task may be allocated for performance tuning in that same iteration or in the next one if the time box for performance tasks is over.

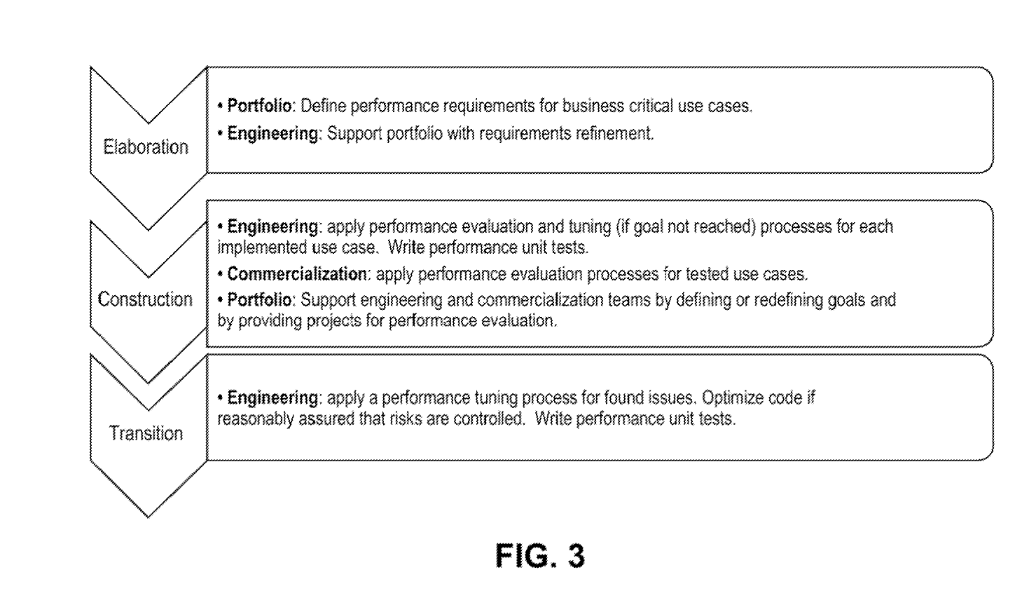

As mentioned above, three teams (portfolio, engineering, and commercialization) may have roles in performing the method 100. FIG. 3 illustrates a summary of how each team may act in project life cycle to be in compliance with the method 100, according to an embodiment. The team performance roles may be broken out into three phases: Elaboration, Construction, and Transition. During Elaboration, the portfolio team may define performance requirements for business critical use cases. The engineering team may support the portfolio team with requirements refinement. Thus, during Elaboration, the use case may be built, among other things, with feedback from an end-user. During the Construction phase, the engineering team may apply the performance evaluation and tuning processes for each implemented use case. The commercialization team may apply performance evaluation processes for the tested use cases, and the portfolio team may support engineering and commercialization teams by defining or redefining goals and by providing projects for performance evaluation. Finally, during the Transition phase, the Engineering team may apply performance tuning processes for the found issues. In at least one case, the Engineering team may optimize code if it is generally certain that risks are controlled, and, finally, may write performance tests.

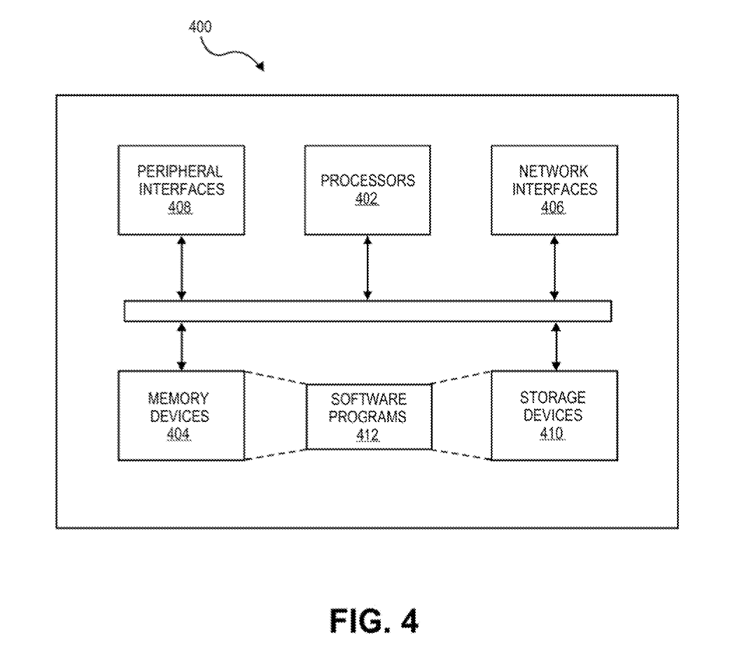

Embodiments of the disclosure may also include one or more systems for implementing one or more embodiments of the method 100. FIG. 4 illustrates a schematic view of such a computing or processor system 400, according to an embodiment. The processor system 400 may include one or more processors 402 of varying core configurations (including multiple cores) and clock frequencies. The one or more processors 402 may be operable to execute instructions, apply logic, etc. It will be appreciated that these functions may be provided by multiple processors or multiple cores on a single chip operating in parallel and/or communicably linked together. In at least one embodiment, the one or more processors 402 may be or include one or more GPUs.

The processor system 400 may also include a memory system, which may be or include one or more memory devices and/or computer-readable media 404 of varying physical dimensions, accessibility, storage capacities, etc. such as flash drives, hard drives, disks, random access memory, etc., for storing data, such as images, files, and program instructions for execution by the processor 402. In an embodiment, the computer-readable media 404 may store instructions that, when executed by the processor 402, are configured to cause the processor system 400 to perform operations. For example, execution of such instructions may cause the processor system 400 to implement one or more portions and/or embodiments of the method described above.

The processor system 400 may also include one or more network interfaces 406. The network interfaces 406 may include any hardware, applications, and/or other software. Accordingly, the network interfaces 406 may include Ethernet adapters, wireless transceivers, PCI interfaces, and/or serial network components, for communicating over wired or wireless media using protocols, such as Ethernet, wireless Ethernet, etc.

The processor system 400 may further include one or more peripheral interfaces 408, for communication with a display screen, projector, keyboards, mice, touchpads, sensors, other types of input and/or output peripherals, and/or the like. In some implementations, the components of processor system 400 need not be enclosed within a single enclosure or even located in close proximity to one another, but in other implementations, the components and/or others may be provided in a single enclosure.

The memory device 404 may be physically or logically arranged or configured to store data on one or more storage devices 410. The storage device 410 may include one or more file systems or databases in any suitable format. The storage device 410 may also include one or more software programs 412, which may contain interpretable or executable instructions for performing one or more of the disclosed processes. When requested by the processor 402, one or more of the software programs 412, or a portion thereof, may be loaded from the storage devices 410 to the memory devices 404 for execution by the processor 402.

Those skilled in the art will appreciate that the above-described componentry is merely one example of a hardware configuration, as the processor system 400 may include any type of hardware components, including any necessary accompanying firmware or software, for performing the disclosed implementations. The processor system 400 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 400 may be used to execute programs according to instructions received from another program or from another processor system altogether. Similarly, commands may be received, executed, and their output returned entirely within the processing and/or memory of the processor system 400. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A method for performance evaluation and tuning, comprising:
defining a performance goal for a variable in a scenario of an execution of an application;
executing, using a processor, the application using the scenario, after defining the performance goal;
recording a value of the variable during execution of the application, or after execution of the application, or both;
determining that the value of the variable does not meet the performance goal for the variable;
profiling an execution of the application in the scenario;
determining a non-critical path of the application and a critical path of the application, based on the profiling;
identifying a bottleneck in the critical path based on the profiling;
tuning the application using the profile to address the bottleneck and generate a tuned application, wherein the non-critical path is not tuned;
executing the tuned application using the scenario; and
determining whether the value of the variable for the tuned application meets the performance goal.

2. The method of claim 1, wherein defining the performance goal precedes tuning the application.

3. The method of claim 1, wherein the variable comprises an execution time and the scenario includes a hardware profile and a use case for the application.

4. The method of claim 3, wherein executing comprises providing an input data set that is similar to the use case.

5. The method of claim 1, wherein executing the application comprises executing the application a predetermined number of times, and wherein recording the value comprises averaging the value of the variable for the predetermined number of times that the application is executed.

6. The method of claim 1, wherein executing the application comprises:
executing the application a plurality of times; and
terminating the execution when a list of values of the variable has a standard deviation less than a predetermined value.

7. The method of claim 1, further comprising:
for a predetermined number of times or until a standard deviation of a list of values for the variable is below a predetermined threshold:
starting a timer prior to executing at least a portion of the application, wherein executing the application comprises executing at least the portion of the application after starting the timer;
ending the timer after executing the at least a portion of the application; and
recording a duration of the execution, based on the timer, in the list of variables; and
determining an average of the list of values as the value of the variable.

8. The method of claim 1, wherein determining whether the value of the variable for the tuned application meets the performance goal comprises determining that the value of the variable for the tuned application does not meet the performance goal, the method further comprising:
locating a second bottleneck based on the profiling; and
further tuning the tuned application to mitigate the second bottleneck.

9. A method, comprising:
receiving a software application and a use case;
determining a scenario for an execution of the software application in a test case, wherein the scenario includes a performance goal;
executing the software application after determining the scenario;
measuring a performance metric from the executing of the software application;
comparing the performance metric to the performance goal;
determining that the performance metric does not satisfy the performance goal;
in response, determining one or more code segments of the software application to be tuned and one or more segments that are non-critical; and
tuning the one or more code segments to be tuned, wherein the one or more segments that are non-critical are not tuned.

10. The method of claim 9, wherein tuning comprises applying a code refactor to the one or more code segments to be tuned.

11. The method of claim 9, wherein executing the software application comprises:
executing the software application a plurality of times;
recording the performance metric for each of the plurality of times the software application is executed, such that a list of performance metrics is generated; and
averaging members of the list of performance metrics to establish the performance metric.

12. The method of claim 11, wherein executing the software application the plurality of times comprises executing the software application until a standard deviation of the list of performance metrics is below a threshold.

13. The method of claim 12, further comprising determining the threshold as a percentage of the performance goal.

14. The method of claim 9, wherein the performance metric is a measurement of an execution time of at least a portion of the software application.

15. The method of claim 9, further comprising establishing the performance metric as a baseline prior to tuning the software application.

16. The method of claim 15, further comprising:
executing the software application after tuning to establish a second performance metric; and
comparing the second performance metric with the baseline to determine an efficacy of the tuning.

17. The method of claim 9, further comprising determining the performance metric to be stricter than a benchmark related to another software application.

18. The method of claim 9, wherein the scenario further comprises a hardware profile, a benchmark, and a measurement criterion.

19. A method, comprising:
defining a performance goal for a variable in a scenario of an execution of an application;
executing, using a processor, the application using the scenario, after defining the performance goal;
recording a value of the variable during execution of the application, or after execution of the application, or both;
determining that the value of the variable does not meet the performance goal for the variable;
profiling an execution of the application in the scenario;
determining a non-critical path of the application and a critical path of the application, based on the profiling;
identifying a bottleneck in the critical path based on the profiling;
tuning the application using the profile to address the bottleneck and generate a tuned application;
determining not to tune the non-critical path;
executing the tuned application using the scenario; and
determining whether the value of the variable for the tuned application meets the performance goal.

20. The method of claim 19, further comprising defining a use case for the application, wherein defining the scenario is based on the use case, and wherein the scenario includes a benchmark, a measurement criterion for the variable, and a hardware profile.
